(19) United States
(12) Patent Application Publication
(10) Pub. No.: US 2015/0262113 A1
(43) Pub. Date: Sep. 17, 2015

(54) WORK STATUS MONITORING AND REPORTING

(71) Applicant: Bank of America Corporation, Charlotte, NC (US)

(72) Inventors: Luis D. Carvajal Chavarria, San Jose (CR); Gustavo Ruiz Montoya, San Jose (CR)

(73) Assignee: Bank of America Corporation, Charlotte, NC (US)

(21) Appl. No.: 14/204,137

(22) Filed: Mar. 11, 2014

(51) Int. Cl. G06Q 10/06

(52) U.S. Cl. CPC G06Q 10/063114

(57) ABSTRACT

Systems, methods, and computer program products for work status monitoring and reporting are provided. Embodiments of the invention involve a memory device; and a processing device operatively coupled to the memory device, wherein the processing device is configured to connect to a work status tracking application, at a predetermined time interval to obtain a current work status for a plurality of financial institution associates, retrieve a last-in-time work status log entry for each of the one or more financial institution associates, determine that one or more financial institution associates has a change in work status, create a current work status log entry for the one or more financial institution associates determined to have the change in work status, and generate a report that indicates work status of at least one of the financial institution associates over a predetermined time period.

### FIELD

In general, embodiments of the invention relate to monitoring user activity and, more particularly, to monitoring and reporting financial institution associates activity.

### BACKGROUND

Unified communication is generally the integration of real-time communication services such as instant messaging, presence information, telephony, video conferencing, data sharing, call control, and speech recognition. Unified communication can provide significant benefits to entities of any size to manage all communications as a single entity, including the ability for users to have a single interface into all of their communications functions, the ability for entities to make faster decisions, and reduce overall costs because of the integration of today's distinct communication silos into a single communications platform.

Monitoring and reporting time utilization and tardiness typically includes gathering data from several sources to produce accurate and simplified information. However, these sources are decentralized and as a result require increased time and manual work to produce simplified reports, thus resulting in additional expenditure for the entity in terms of resources and man-hours.

In today's computer networking environments, unified communication includes presence information as a form of status indicator that conveys ability and willingness of a user to communicate. Typically, a user's client provides presence information via a network connection to a presence service and can be made available for distribution to other users to convey availability for communication. Therefore, a need exists to develop other methods, apparatus, and computer program products for user presence monitoring. The desired methods, apparatus, and computer program products for real-time monitoring of user activity should alleviate problems associated with inefficiencies in the monitoring and reporting process. Further, the desired methods, apparatus, and computer program products should leverage the advantages provided by unified communication to assist in the monitoring and reporting process.

### SUMMARY OF INVENTION

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. Its sole purpose is to present some concepts of one or more embodiments in a simplified form as a prelude to the more detailed description that is presented later.

The embodiments of the present invention include a method, apparatus, and computer program product for tracking work activity and time distribution to efficiently utilize resources to improve efficiency in a business environment, such as a financial institution call center or the like.

Embodiments of the invention include systems, computer program products, and methods for work status monitoring and reporting. Specific embodiments of the invention comprises an apparatus including a work status monitoring and reporting module configured to (a) connect to a work status tracking application, at a predetermined time interval to obtain a current work status for a plurality of financial institution associates, (b) retrieve, from a work status database, a last-in-time work status log entry for each of the one or more financial institution associates, (c) determine that one or more financial institution associates has a change in work status by comparing the current work status with last-in-time work status log entry, (d) create a current work status log entry for the one or more financial institution associates determined to have the change in work status, wherein the current work status log entry indicates (1) a financial institution associate, (2) a work status type and (3) a time associated with the change in work status, and (e) generate a report that indicates work status of at least one of the financial institution associates over a predetermined time period.

In some embodiments of the apparatus, the work status monitoring and reporting module is further configured to obtain the current work status, wherein the current work status is one of (1) away, (2) busy, (3) online, (4) offline, (5) idle, or (6) be right back.

In some embodiments of the invention, the work status monitoring and reporting module is further configured to initiate the presentation of a first user interface. The first user interface enables a user, such as a financial institution manager, to execute one or more options, including (1) a timer option, (2) a report option, and/or (3) an administrator option, wherein executing includes accessing the work status database.

In some embodiments of the invention, the work status monitoring and reporting module is further configured to initiate the presentation of a second user interface. The presentation of the second user interface is based on a user's execution of the timer option. The second user interface includes a start option and a pause option.

In some embodiments of the apparatus, the work status monitoring and reporting module is further configured to enable the financial institution manager to retrieve, from the work status database every five seconds, the current work status associated with each of the one or more financial institution associates based on the user's execution of the start option until the user's execution of the pause option. The user's execution of the pause option enables the work status monitoring and reporting module to temporarily stop retrieving the current work status.

In some embodiments of the apparatus, the work status monitoring and reporting module is further configured to initiate the presentation of a third user interface based on a user's execution of the report option. The execution of the report option enables the user to generate a report based on the one or more work statuses in the work status database. The report further includes an aggregated time associated with the one or more work statuses for the one or more financial institution associates over a predetermined time period.

In some embodiments of the apparatus, the work status monitoring and reporting module is further configured to generate the report for each of the one or more financial institution associates based on a percentage of the aggregated time associated with the one or more retrieved work statuses relative to the predetermined time period. In such embodiments of the invention the report may be a pie chart.

In some embodiments of the apparatus, the work status monitoring and reporting module is further configured to generate the report for each of the one or more financial institution associates working under a financial institution manager based on a percentage of aggregated time associated with the one or more retrieved work statuses relative to the predetermined time period. The report is a comparison of the percentage of aggregated time a work status is associated with a financial institution associate. In such embodiments of the invention, the report is a stacked bar chart.

In some embodiments of the apparatus, the work status monitoring and reporting module is further configured to generate the report for each of the one or more financial institution associates working under a financial institution manager based on a percentage of aggregated time associated with the one or more retrieved work statuses relative to the predetermined time period. The report is a comparison of the percentage of aggregated time for each of the one or more financial institution associates. In such embodiments of the invention the report is a stacked bar chart.

In some embodiments of the apparatus, the work status monitoring and reporting module is further configured to generate the report based on an initial log-in time and a final log-out time.

In some embodiments of the apparatus, the work status monitoring and reporting module is further configured to generate a report based on a user's selection of a time period. Selecting a time period further includes selecting a first time stamp and a second time stamp.

In some embodiments of the apparatus, the work status monitoring and reporting module is further configured to generate a report based on a user's selection of one or more financial institution associates working under a financial institution manager. Selecting further includes selecting from a drop-down list of one or more available financial institution managers.

In some embodiments of the apparatus, the work status monitoring and reporting module is further configured to initiate the presentation of a fourth user interface based on a user's execution of the administrator option. The execution of the administrator option is further configured to enable the user to clear the work status database.

Further specific embodiments of the invention are defined by a method for monitoring and reporting work status. The method includes (a) connecting to a work status tracking application, at a predetermined time interval to obtain a current work status for a plurality of financial institution associates, (b) retrieving from a work status database, a last-in-time work status log entry for each of the one or more financial institution associates, (c) determining that one or more financial institution associates has a change in work status by comparing the current work status with the last-in-time work status log entry, (d) creating a current work status log entry for the one or more financial institution associates determined to have the change in work status, wherein the current work status log entry indicates (1) a financial institution associate, (2) a work status type and (3) a time associated with the change in work status, and (e) generating a report that indicates work status of at least one of the financial institution associates over a predetermined time period.

In some embodiments of the method, retrieving from the work status database further comprises retrieving one or more work statuses associated with one or more financial institution associates, wherein the one or more work status is one of (1) away, (2) busy, (3) online, (4) offline, (5) idle, or (6) be right back.

In some embodiments of the method, determining the change in work status further comprises retrieving, every five seconds, from the work status database, the current work status associated with each of the one or more financial institution associates based on receiving a user's input.

In some embodiments of the method, connecting to the work status tracking application further comprises authenticating the user based on receipt of one or more authentication credentials.

In some embodiments of the method, creating further comprises updating the work status database by replacing the last-in time work status with the current work status for the one or more financial institution associates.

A computer program product for monitoring and reporting work status defines other embodiments of the invention. The computer program product includes a non-transitory computer-readable medium. The medium includes a first set of codes for causing a computer to, connect to a work status tracking application, at a predetermined time interval to obtain a current work status for a plurality of financial institution associates. The computer-readable medium further includes a second set of codes for causing a computer to, retrieve, from a work status database, a last-in-time work status log entry for each of the one or more financial institution associates. In addition the computer-readable medium includes a third set of codes for causing a computer to, determine that one or more financial institution associates has a change in work status by comparing the current work status with last-in-time work status log entry. Additionally, the computer-readable medium includes a fourth set of codes for causing a computer to, create a current work status log entry for the one or more financial institution associates determined to have the change in work status, wherein the current work status log entry indicates (1) a financial institution associate, (2) a work status type and (3) a time associated with the change in work status. Moreover, the computer-readable medium includes a fifth set of codes for causing a computer to, generate a report that indicates work status of at least one of the financial institution associates over a predetermined time period.

In some embodiments of the computer-program product, the second set of codes is further configured to cause the computer to retrieve one or more work statuses associated with one or more financial institution associates, wherein the one or more work statuses is one of (1) away, (2) busy, (3) online, (4) offline, (5) idle, or (6) be right back.

### BRIEF DESCRIPTION OF THE DRAWINGS

Having thus described embodiments of the invention in general terms, reference will now be made to the accompanying drawings, which are not necessarily drawn to scale, and wherein:

FIG. 1 illustrates an apparatus configured for monitoring and reporting a work status associated with a financial institution associate, in accordance with embodiments of the present invention.

FIG. 2 illustrates an apparatus configured for a work status monitoring and reporting module, in accordance with embodiments of the present invention.

FIG. 3 illustrates a process flow associated with monitoring and reporting a work status, in accordance with embodiments of the present invention.

FIGS. 4A and 4B illustrate a first user interface for work status monitoring and reporting module, in accordance with embodiments of the present invention.

FIG. 5A illustrates a third user interface for work status monitoring and reporting module, in accordance with embodiments of the present invention.

FIGS. 5B and 5C illustrate a first reporting interface for generating a report, in accordance with embodiments of the present invention.

FIG. 5D illustrates a second reporting interface for generating a report, in accordance with embodiments of the present invention.

FIG. 6 illustrates a fourth user interface for work status monitoring and reporting module, in accordance with embodiments of the present invention.

FIG. 7A-7G illustrates a spreadsheet interface for generating a report, in accordance with embodiments of the present invention.

### DETAILED DESCRIPTION OF EMBODIMENTS OF THE INVENTION

Embodiments of the present invention will now be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure will satisfy applicable legal requirements. Like numbers refer to like elements throughout. Although some embodiments of the invention described herein are generally described as involving a “financial institution,” one of ordinary skill in the art will appreciate that the invention may be utilized by other businesses that take the place of or work in conjunction with financial institutions to perform one or more of the processes or steps described herein as being performed by a financial institution.

As will be appreciated by one of skill in the art in view of this disclosure, the present invention may be embodied as an apparatus (e.g., a system, computer program product, and/or other device), a method, or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product comprising a computer-usable storage medium having computer-usable program code/computer-readable instructions embodied in the medium.

Any suitable computer-usable or computer-readable medium may be utilized. The computer usable or computer readable medium may be, for example but not limited to, an electronic, magnetic, optical, electromagnetic, infrared, or semiconductor system, apparatus, or device. More specific examples (e.g., a non-exhaustive list) of the computer-readable medium would include the following: an electrical connection having one or more wires; a tangible medium such as a portable computer diskette, a hard disk, a time-dependent access memory (RAM), a read-only memory (ROM), an erasable programmable read-only memory (EPROM or Flash memory), a compact disc read-only memory (CD-ROM), or other tangible optical or magnetic storage device.

Computer program code/computer-readable instructions for carrying out operations of embodiments of the present invention may be written in an object oriented, scripted or unscripted programming language such as Java, Perl, Smalltalk, C++ or the like. However, the computer program code/computer-readable instructions for carrying out operations of the invention may also be written in conventional procedural programming languages, such as the “C” programming language or similar programming languages.

Embodiments of the present invention are described below with reference to flowchart illustrations and/or block diagrams of methods or apparatuses (the term “apparatus” including systems and computer program products). It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a particular machine, such that the instructions, which execute by the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instructions, which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions, which execute on the computer or other programmable apparatus, provide steps for implementing the functions/acts specified in the flowchart and/or block diagram block or blocks. Alternatively, computer program implemented steps or acts may be combined with operator or human implemented steps or acts in order to carry out an embodiment of the invention.

Presence information is a growing tool towards more effective and efficient communication within a business setting. Presence information allows you to instantly see users available in a corporate network, giving more flexibility to set up short-term meetings and conference calls. The present invention discloses an apparatus, method, and computer program product to use the presence information in a business environment to monitor and report a financial institution associate's work status. In some specific embodiments of the invention, the financial institution associate may be a call center associate/employee.

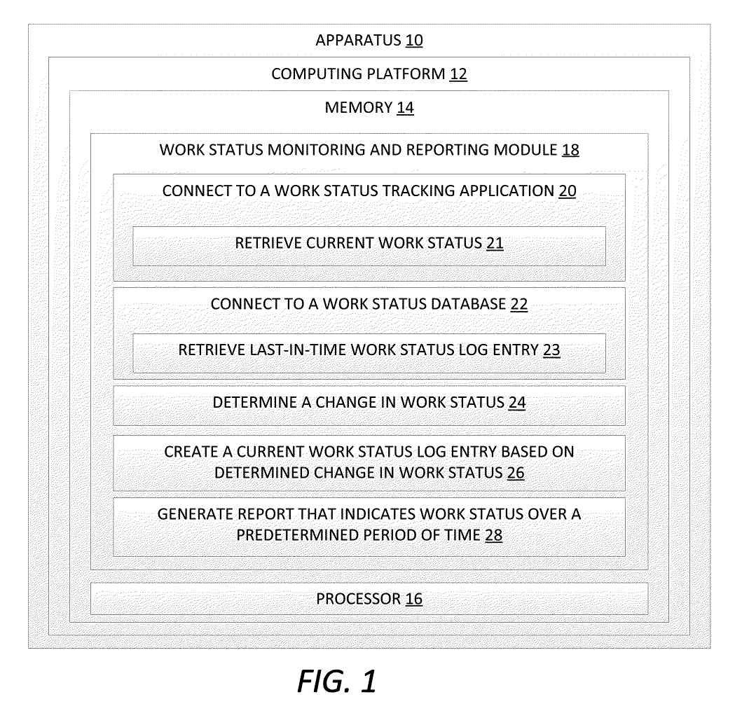

Referring to FIG. 1, a block diagram is presented of an apparatus 10 configured for monitoring and reporting the work status associated with a financial institution associate, in accordance with embodiments of the present invention. The apparatus includes a computing platform 12 having a memory 14 and at least one processor 16 in communication with the memory 14. The memory 14 of the apparatus 10 stores the work status monitoring and reporting module 18. The work status monitoring and reporting module 18 is configured to connect to a work status tracking application 20 using a network service. A specific example of a network service may include, but is not limited to, a banking network service or the like. In some embodiments, connecting to the work status tracking application may include a successful validation of a user's authentication credentials. In one aspect, the work status monitoring and reporting module may be configured to retrieve a current work status for a plurality of financial institution associates 22. In addition, the work status monitoring and reporting module may be configured to retrieve, from a work status database 22, a last-in-time work status log entry for each of the one or more financial institution associates 23.

In some embodiments, a work status database may include one or more records and each of the one or more records may include one or more fields. In one aspect, a record in the work status database may include an employee of the financial institution (for example, a financial institution associate, a financial institution manager, or the like). In another aspect, each record in the work status database may include one or more work status fields and a time period associated with the one or more work status fields. For example, the work status fields may be indicative of the financial institution associate's presence in a network-based service (e.g., a status indicator application or the like) such as away, busy, online, offline, idle, be right back, or the like. The time period associated with the work status fields in the work status database may be an aggregation of an amount of time a financial institution associate's presence information has reflected the specific work status field. For example, if a financial institution associate's work status is “online” for 20 minutes, offline for 10 minutes and online again for the next 30 minutes, the work status field “online” in the work status database corresponding to the financial institution associate's record will be 50 minutes and the work status field “offline” in the work status database corresponding to the financial institution associate's record will be 10 minutes. In one aspect, the work status field in the work status database may include a log-on time and a log-off time. In some embodiments, a financial institution manager may have one or more financial institution associates working under his/her supervision.

The work status monitoring and reporting module 18 may be configured to retrieve the current work status associated with the financial institution associate at a predetermined time interval. In one aspect, the last-in-time work status log entry is the work status associated with the financial institution associate at a previous predetermined interval, and is reflected in the work status field corresponding to the financial institution associate's record in the work status database. The current work status is the work status associated with the financial institution associate at an interval succeeding the previous predetermined time interval. In response to retrieving the current work status, the work status monitoring and reporting module 18 is configured to determine that the one or more financial institution associates has a change in work status 24 by comparing the current work status to the last-in-time work status log entry. In response to determining a change in the work status associated with the financial institution associate, the work status monitoring and reporting module 18 is configured to create a current work status log entry for the one or more financial institution associates determined to have the change in work status. In one aspect, the module 18 may be configured to create a current work status log entry if the current work status is not reflected as one of the work status field in the work status database 26. In another aspect, the module 18 may be configured to aggregate a time period defined by a time duration between the last-in-time work status log entry and the current work status with the time period associated with the current status reflected in the work status field. For example, if a financial institution associate's record has an online work status field and an offline work status field, each being associated with a time period, a current work status indicating a field other than the online work status or the offline work status may include the creation of a current work status log entry reflecting the current work status with a corresponding time period. On the other hand, if the current work status indicates either the online work status field or the offline work status field, the time period associated with the difference between the last-in-time work status log entry and the current work status is added to the existing time period.

In response to creating a current work status log entry, the work status monitoring and reporting module 18 may be configured to generate a report that indicates the work status associated with the financial institution associate over a predetermined time period 28.

The apparatus 10 may include any type and/or combination of one or more computing devices. In specific embodiments the apparatus may be a server in communication with a mobile communication device or a mobile communication device. The apparatus 10 is operable to receive and execute modules, routines and applications, such as authentication requirements module 18 and the like.

The apparatus 10 includes computing platform 12 that can receive and execute routines and applications. Computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 1) that interfaces with any resident programs, such as work status monitoring and reporting module 18 or the like, stored in the memory 14 of apparatus 10. Processor 16 includes various processing subsystems (not shown in FIG. 1) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of work status monitoring and reporting module 18 obviating the need for such applications and modules to be stored in the memory.

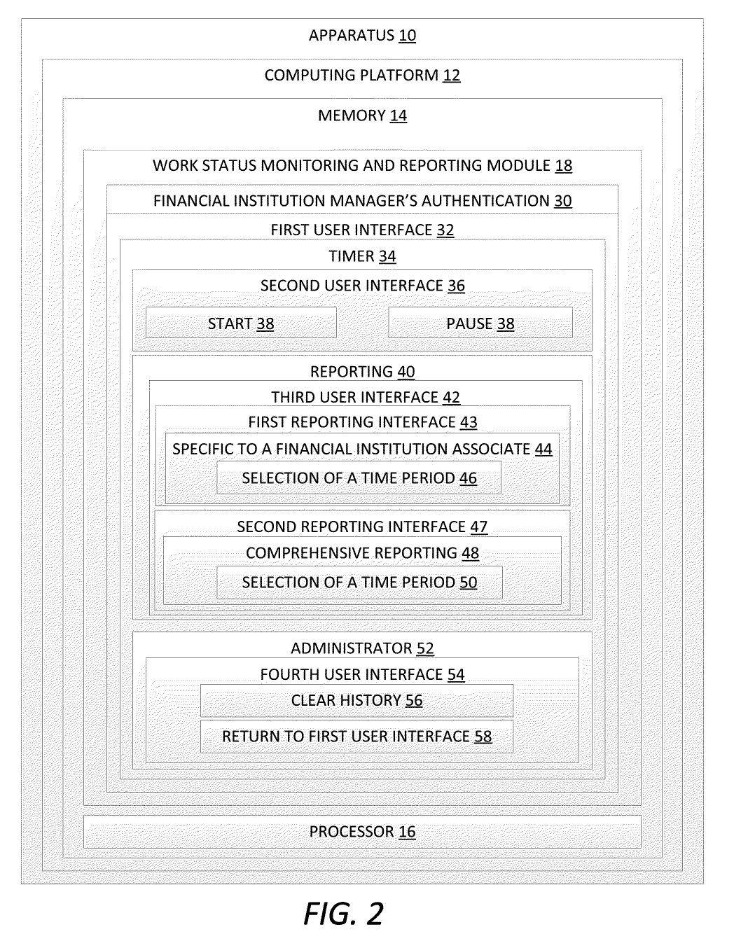

Referring to FIG. 2, a block diagram for an apparatus 10 configured for a work status monitoring and reporting module, in accordance with embodiments of the present invention is presented. The work status monitoring and reporting module 18 is further configured to initiate the presentation of a first user interface 32 based on at least a successful validation of one or more authentication credentials associated with the financial institution manager 30. In some embodiments, any employee may be capable of generating a report if the one or more authentication credentials of the employee are successfully validated. In one aspect, the one or more user authentication credentials may include a username, password, or the like. In one aspect, the first user interface 32 may include a timer option 34, a reporting option 40, and an administrator option 52.

The module 18 may further be configured to initiate the presentation of a second user interface 36 in response to a user's selection of the timer option 34. In some embodiments, the timer option 34 may enable the user's selection of a start option 38 to retrieve the current work status associated with the one or more financial institution associates. In some embodiments, the work status monitoring and reporting module is further configured to enable the user to retrieve, every five seconds, from the work status database, the current work status associated with each of the one or more financial institution associates based on at least the user's execution of the start option 38 until the user's execution of the pause option 38, wherein the user's execution of the pause option enables the work status monitoring and reporting module to temporarily stop retrieving the current work status.

In some embodiments of the invention, the module 18 is configured to initiate the presentation of a third user interface 42 based on a user's selection of the reporting option 40. In one aspect, the report may be based on the one or more records and fields in the work status database to reflect the time period associated with each of the one or more work status fields for each of the one or more financial institution associates. In some embodiments, the module 18 may be configured to enable the user to generate a report (e.g., graphical report or the like) specific to a financial institution associate 44. In one aspect, the module 18 may be configured to initiate the presentation of a first reporting interface 43. In some embodiments, the first reporting interface 43 may enable a user to generate the report based on a user's selection of a financial institution associate from a list of financial institution associates. In another aspect, in addition to a selection of a financial institution associate, the module 18 may enable a user's selection of a time period 46. In one aspect, the time period 50 may be defined as the time duration between a first time stamp and a second time stamp.

In some other embodiments of the invention, the module 18 may be configured to enable the user to generate a comprehensive report 48 of the all the financial institution associates in the work status database. In one aspect, the module 18 may be configured to initiate the presentation of a second reporting interface 43. In some embodiments, the second reporting interface 43 may enable a user to generate the report based on a user's selection of a time period 50 defined by a first time stamp and a second time stamp.

In some embodiments of the invention, the module 18 may be configured to initiate the presentation of a fourth user interface 54 based on at least a financial institution manager's selection of the administrator option 52. In one aspect, the module 18 may be configured to enable the user to clear the database 58 as part of a periodic purge. In another aspect, the module 18 may be configured to enable the user to return to the first user interface for selection of a different option by selecting the return to first user interface option 58.

The apparatus 10 may include any type and/or combination of one or more computing devices. In specific embodiments the apparatus may be a server in communication with a mobile communication device or a mobile communication device. The apparatus 10 is operable to receive and execute modules, routines and applications, such as authentication requirements module 18 and the like.

The apparatus 10 includes computing platform 12 that can receive and execute routines and applications. Computing platform 12 includes memory 14, which may comprise volatile and nonvolatile memory such as read-only and/or random-access memory (RAM and ROM), EPROM, EEPROM, flash cards, or any memory common to computer platforms. Further, memory 14 may include one or more flash memory cells, or may be any secondary or tertiary storage device, such as magnetic media, optical media, tape, or soft or hard disk.

Further, computing platform 12 also includes at least one processor 16, which may be an application-specific integrated circuit (“ASIC”), or other chipset, processor, logic circuit, or other data processing device. Processor 16 or other processor such as ASIC may execute an application programming interface (“API”) layer (not shown in FIG. 2) that interfaces with any resident programs, such as work status monitoring and reporting module 18 or the like, stored in the memory 14 of apparatus 10. Processor 16 includes various processing subsystems (not shown in FIG. 2) embodied in hardware, firmware, software, and combinations thereof, that enable the functionality of apparatus 10 and the operability of the apparatus on a network. For example, processing subsystems allow for initiating and maintaining communications, and exchanging data, with other networked devices. Additionally, processing subsystems may include any portion of the functionality of work status monitoring and reporting module 18 obviating the need for such applications and modules to be stored in the memory.

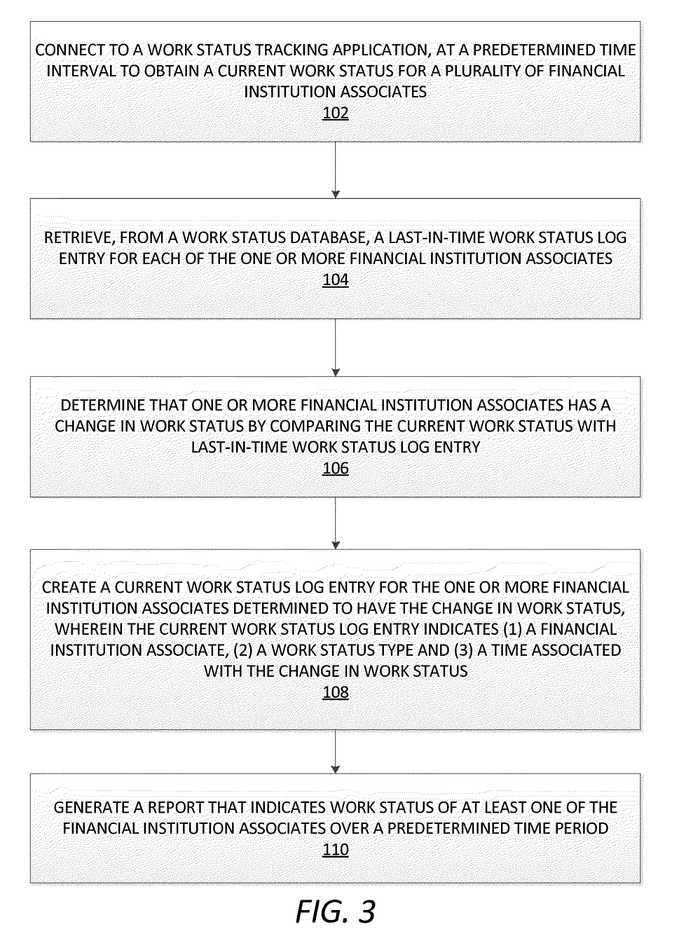

Referring now to FIG. 3, a process flow associated with monitoring and reporting a work status is presented. In some embodiments, the process flow includes a work status monitoring and reporting module to connect to a work status tracking application, at a predetermined time interval to obtain a current work status for a plurality of financial institution associates, as shown in block 102. In addition, the process flow includes retrieving, from a work status database, a last-in-time work status log entry for each of the one or more financial institution associates, as shown in block 104. In response to retrieving, the process includes determining that the one or more financial institution associates has a change in work status by comparing the current work status with the last-in-time work status log entry, as shown in block 106. In response to determining, the process may include a module configured to create a current work status log entry for the one or more financial institution associates determined to have the change in work status, wherein the current work status log entry indicates (1) a financial institution associate, (2) a work status type and (3) a time associated with the change in work status, as shown in block 108. In response to creating a current work status log entry, the process flow may include a module configured to generate a report that indicates work status of at least one of the financial institution associates over a predetermined time period, as shown in block 110.

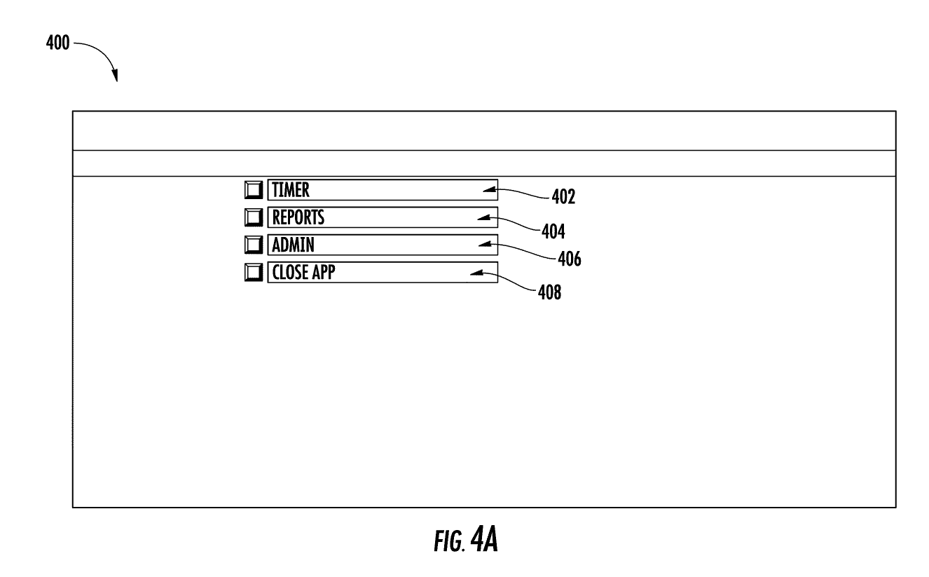

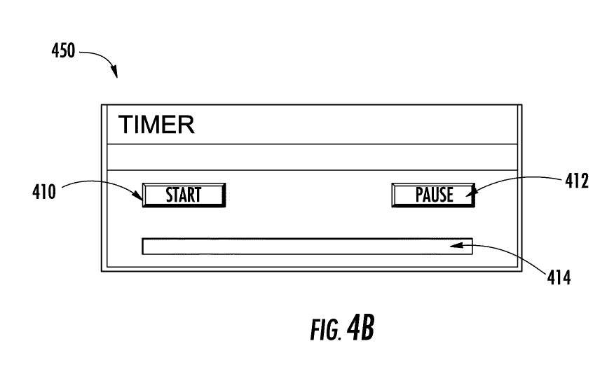

Referring now to FIG. 4A, a first user interface for work status monitoring and reporting module is presented 400. In one aspect, the first user interface includes an option for user selection including a timer 402, reports 404, and administrator 406. In some embodiments, a financial institution manager's selection of the timer 402 initiates the presentation of second user interface 450 as shown in FIG. 4B. In one aspect, the second user interface 450 includes a start 410, a pause 412, and a progress bar 414. The first user interface enables the user to select the start option 410 to begin the work status retrieving process. In some embodiments, the work status retrieving process includes a current work status retrieval and the last-in-time work status log entry from a work status database of one or more financial institution managers to be stored as individual records in the work status database. In one aspect, the work status retrieval process retrieves the current work status associated with one or more financial institution associates periodically (e.g., every five seconds) until receiving a user's input to stop/pause the work status retrieval process using the pause option 412. In this way, the work statuses associated with the one or more financial institution associates may be monitored in real-time. In some embodiments, the progress graphic 414 displays the progress information of the work status retrieval process for each iteration involved between the user's selection of the start option 410 and the pause option 412.

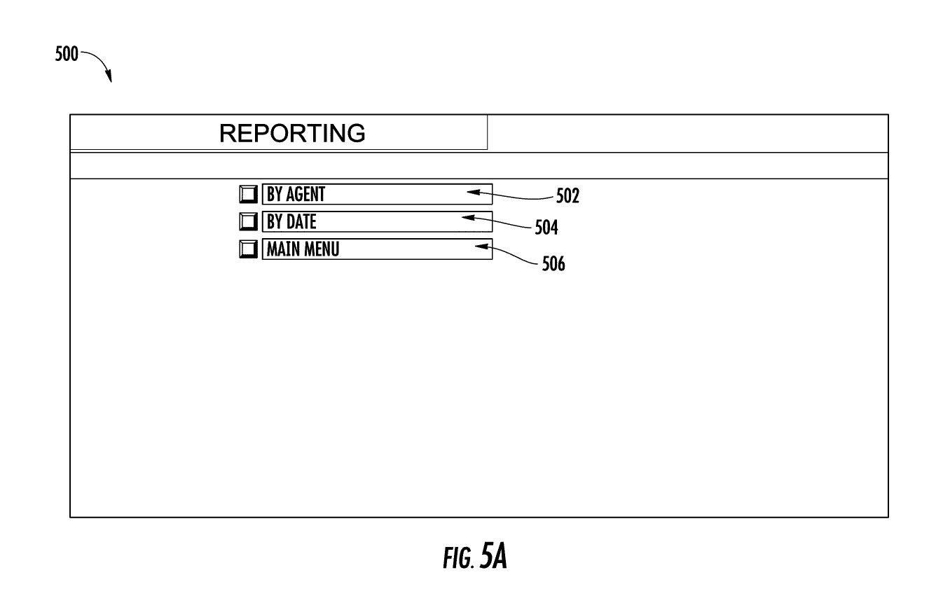

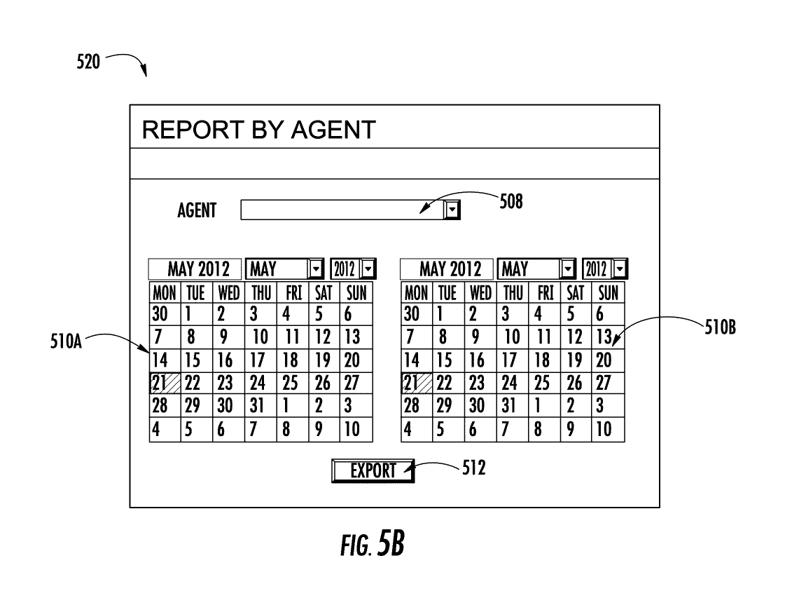

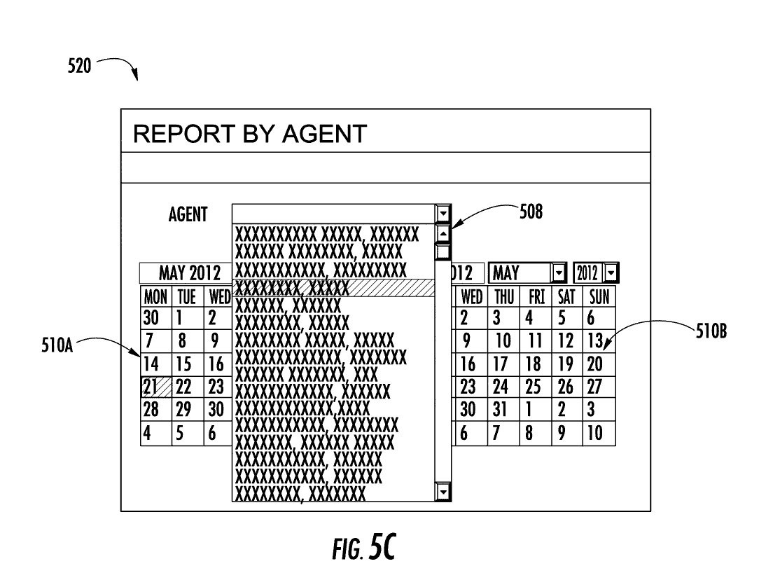

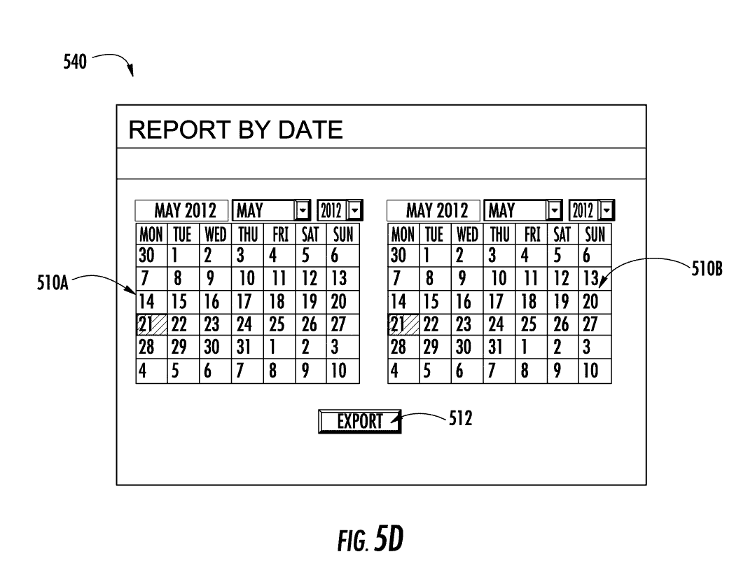

Referring now to FIG. 5A, a third user interface for work status monitoring and reporting module is presented 500. As illustrated, the third user interface 500 enables a user to generate a report (such as a graphical report) based on a particular agent (e.g., financial institution associate, financial institution manager, any employee of the financial institution, or the like) using the “by agent” option 502. In some other embodiments, the third user interface 500 enables the user to generate a report based on a time period defined by a first time stamp and the second time stamp using the “by date” option 504. In one aspect, the third user interface 500 enables the user to return to the first user interface 400 using the “main menu” option 506.

Referring now to FIGS. 5B and 5C, a first reporting interface for generating a report is presented. In some embodiments, a user's selection of the “by agent” option 502 initiates the presentation of the interface. As shown in FIG. 5B, the interface may enable a financial institution manager's selection of an agent from a drop-down list of one or more agents 508. In one aspect, an agent may be a financial institution associate. In another aspect, the agent may be a financial institution manager. In response to the selection of an agent, in some other embodiments, the interface also enables a user's selection of a time period by selecting a first time stamp 510A and a second time stamp 510B. In response to a selection of the time period, the interface may enable the user to generate a report based on a selection of the “export” option 512.

Referring now to FIG. 5D, a second reporting interface for generating a report is presented. In some embodiments, the second reporting interface enables the user to generate a report indicating a work status of all the agents associated with the financial institution. In one aspect, module 18 may be configured to generate a report for one or more groups within the financial institution. For example, a group may include one or more financial institution associates working under a particular financial institution manager. In another example, a group may include one or more financial institution associates assigned to a particular function such as the information technology team, a call center team, a sales team, or the like. In response to a selection of the first time stamp 510A and the second time stamp 510B, the second reporting interface may enable the user to generate a report based on the execution of the “export” option 512.

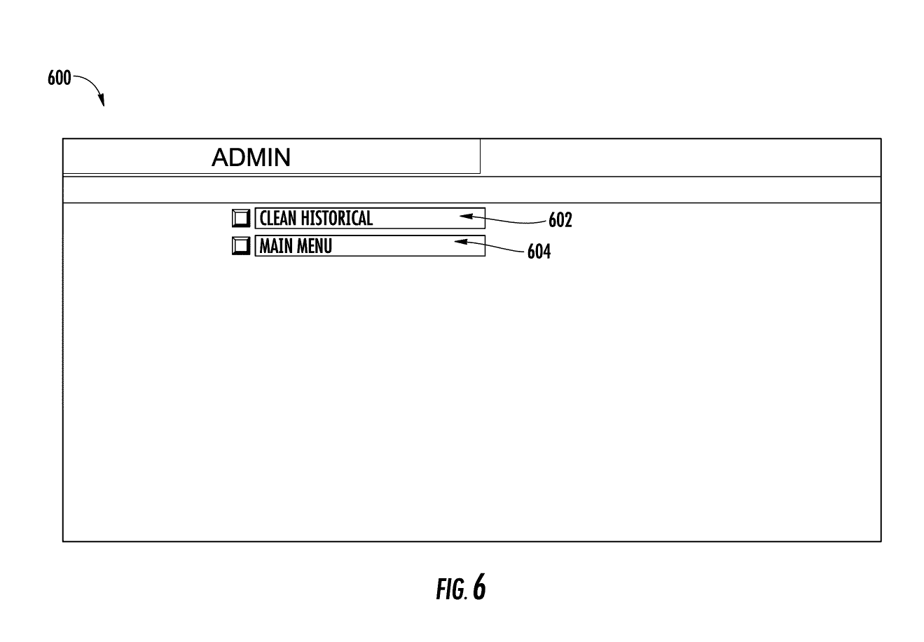

Referring to FIG. 6, a fourth user interface for work status monitoring and reporting module is presented 600. In one aspect, the fourth user interface enables the user to clear the work status database based on the execution of the “clean historical” option 602. Typically, the work status database is cleared periodically. In one aspect, the work status database may be cleared periodically after the user generates a report for a particular period of time. In another aspect, the work status database is cleared to archive the work status associated with the one or more financial institution associates for the particular period of time.

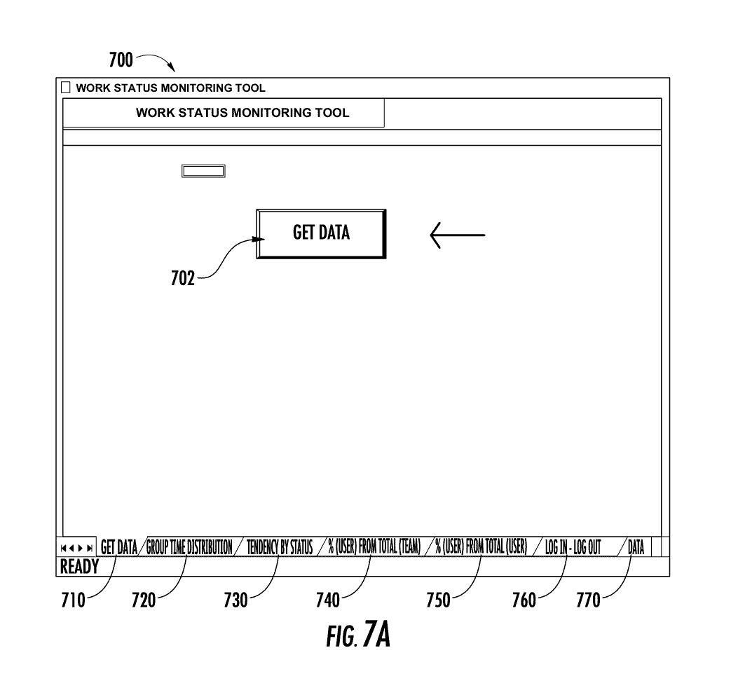

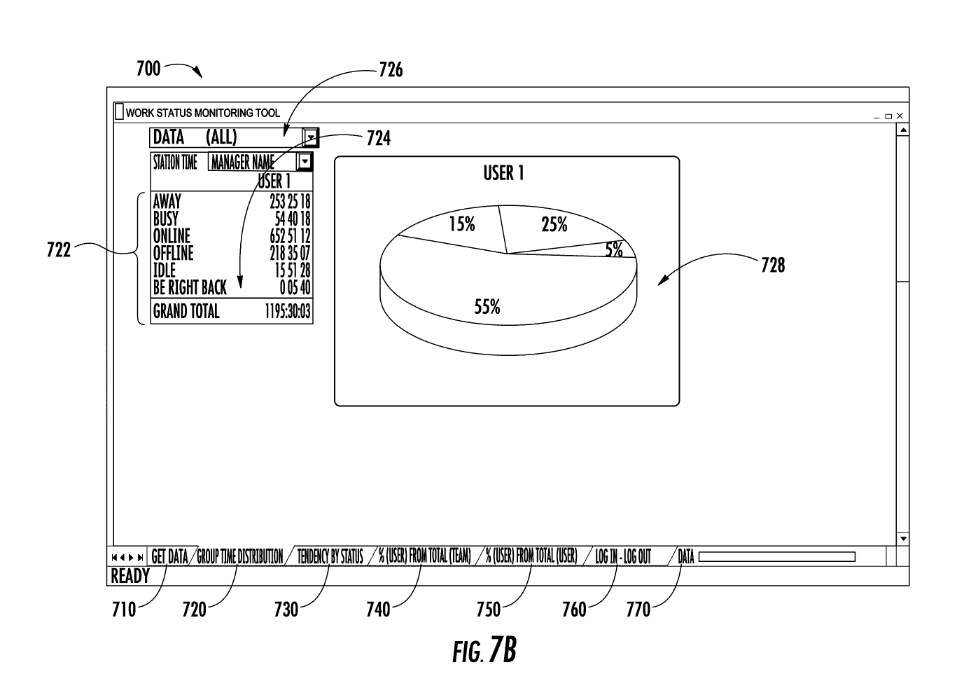

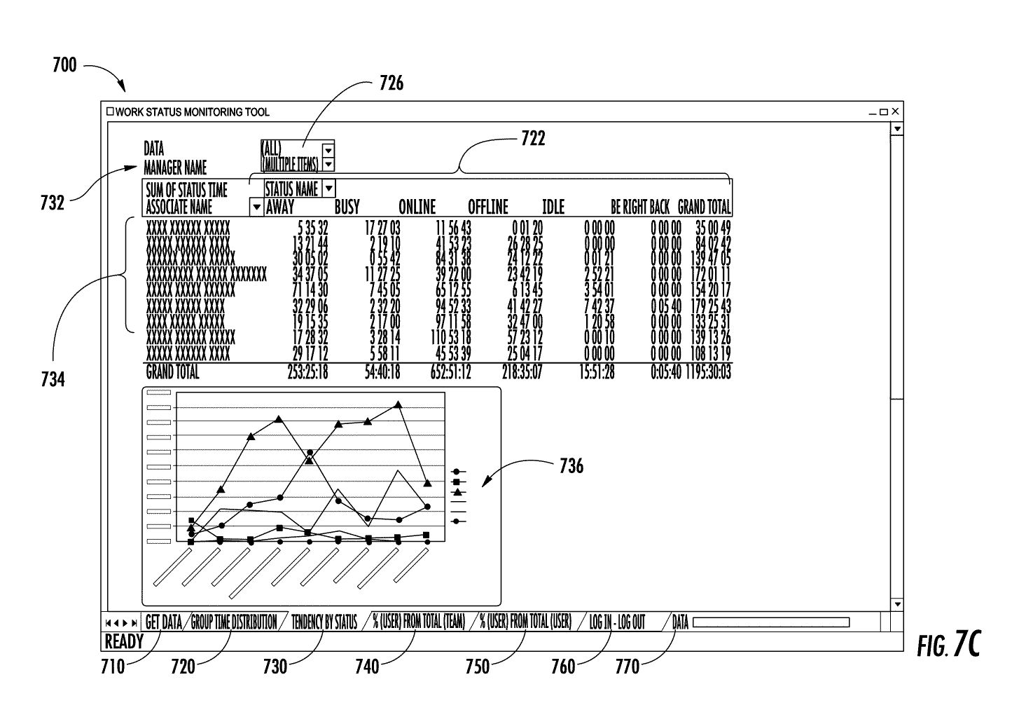

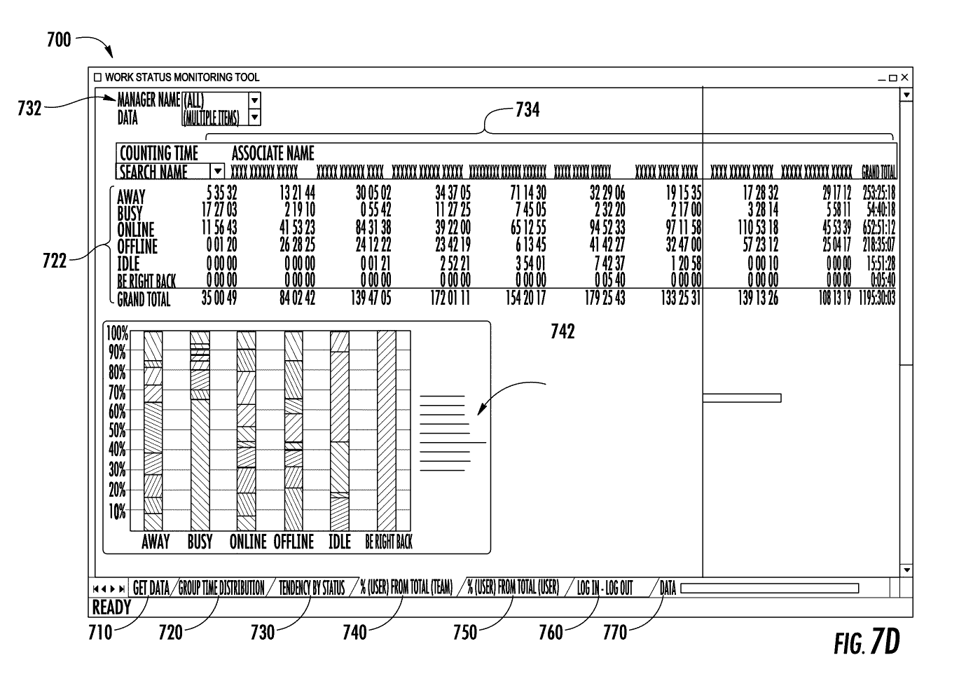

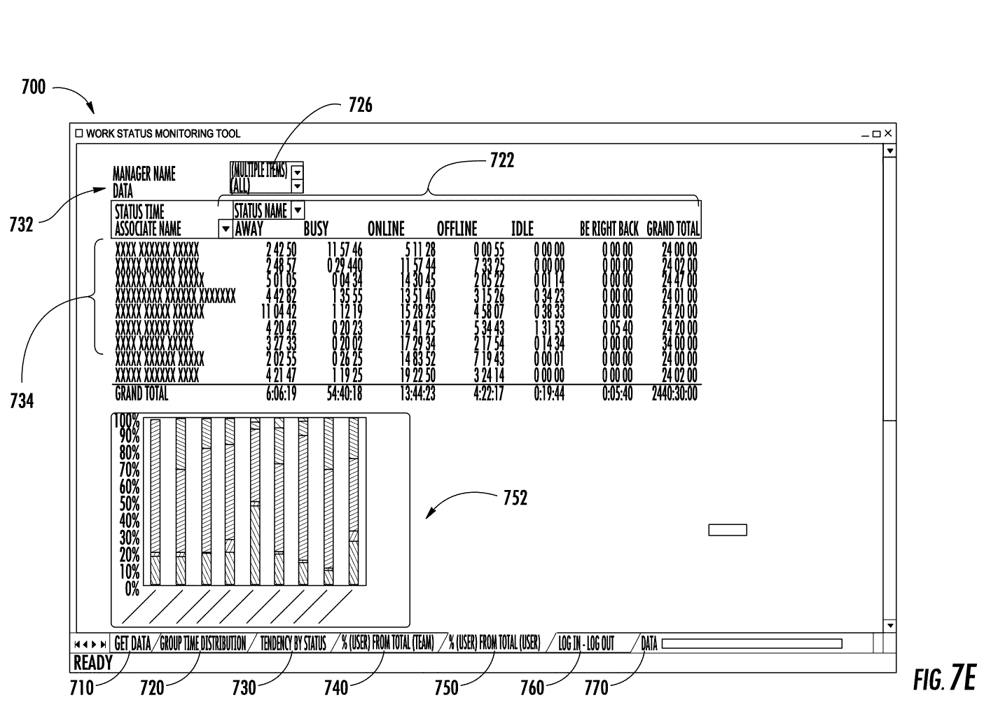

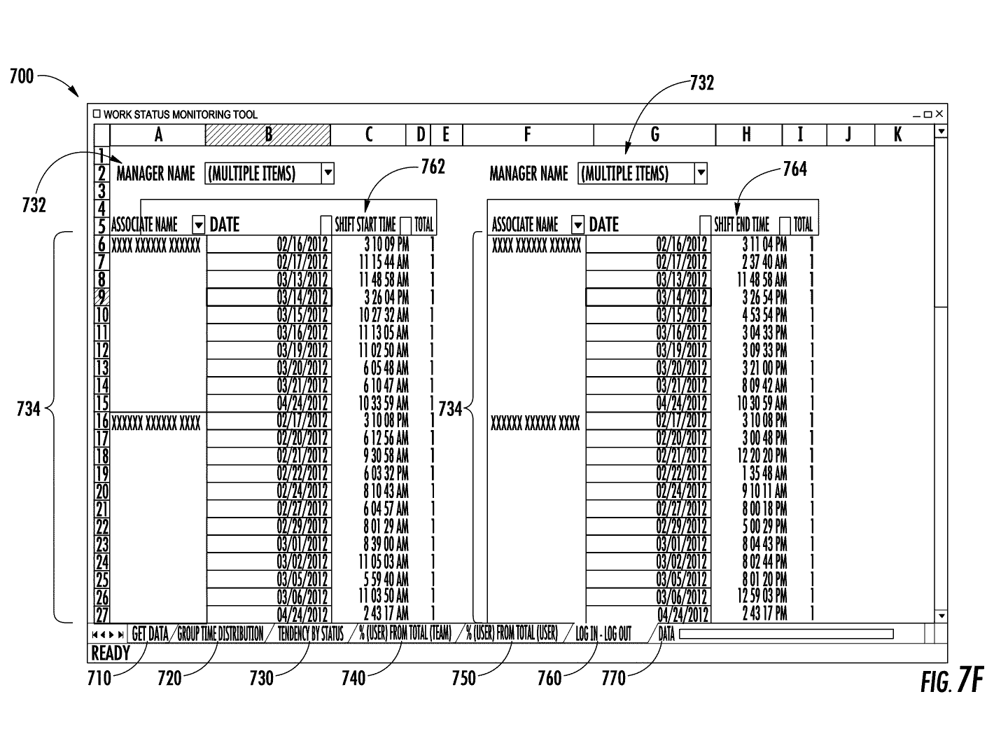

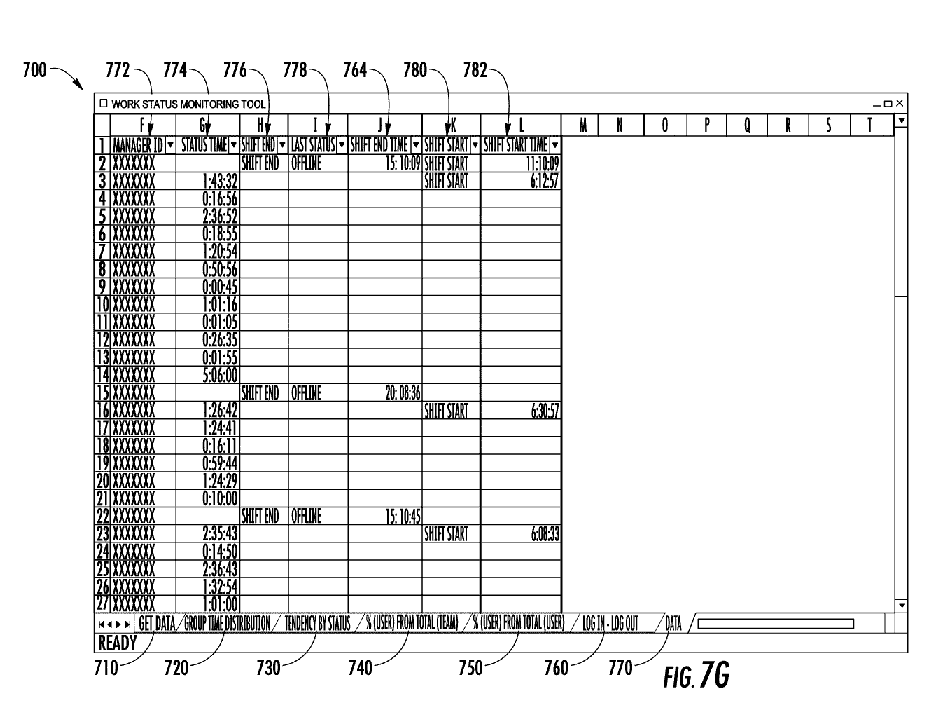

Referring now to FIGS. 7A-7G, a spreadsheet interface for generating a report is presented. In some embodiments, the spreadsheet interface may include one or more tabs to enable the user to navigate between different spreadsheet interface pages for the generation of reports. As shown in FIGS. 7A-7G, the one or more tabs may include a get data 710, group time distribution 720, tendency by status 730, % (User) from total (Team) 740, % (User) from total (User) 750, log-in/log-out (user) 760, and Data 770.

Referring now to FIG. 7A presents a first tab 710 to enable the user to retrieve the data. In some embodiments, the (e.g., work status log entries) by executing the “get data” option 702.

Referring now to FIG. 7B, a second tab 720 is presented that enables the user to generate a report based on a percentage time distribution of work status time period associated with an agent. In some embodiments, the second tab 720 includes a time option 726 enabling the user to select a time period and a manager option 724 enabling the user's selection of a manager/agent (e.g., financial institution manager supervising one or more financial institution associates) from a drop-down list of one or more managers/agents. In one aspect, the user may generate a report based on a percentage distribution of the time period associated with the each of the one or more work statuses, wherein the work statuses reflect the presence information of the selected manager/agent. The second tab 720 also includes one or more work statuses and corresponding time periods 722 associated with the selected manager/agent. In some embodiments, the second tab 720 may enable the user to generate a pie chart 728 reflecting a percentage time distribution of work status associated with an agent.

Referring now to FIG. 7C, a third tab 730 is presented that enables the user to generate a report based on a work status time distribution of one or more agents is presented. In some embodiments, the third tab 730 includes the time option 726 enabling the user to select a time period, a manager option 732 enabling the user's selection of a manager (e.g., financial institution manager supervising one or more financial institution associates) from a drop-down list of one or more managers associated with the financial institution. In one aspect, the third tab 730 initiates the presentation of one or more financial institution associates 734 working under the selected financial institution manager. In some embodiments, the third tab 730 also includes one or more work statuses 722 associated with the one or more financial institution associates 734 with corresponding time periods. In some embodiments, the third tab 730 may enable a user to generate a line graph 736 reflecting the work status time distribution of one or more agents.

Referring now to FIG. 7D, a fourth tab 740 is presented that enables the user to generate a report based on a percentage distribution of the one or more agents and their associated work status time periods. In some embodiments, the fourth tab 740 includes the time option enabling the user to select a time period, a manager option 732 enabling the user's selection of a manager (e.g., financial institution manager supervising one or more financial institution associates) from a drop-down list of one or more managers associated with the financial institution. In one aspect, the fourth tab 740 initiates the presentation of one or more financial institution associates 734 working under the selected financial institution manager. In some embodiments, the fourth tab 740 also includes one or more work statuses 722 associated with the one or more financial institution associates 734 with corresponding time periods. In some embodiments, the fourth tab 740 may enable a user to generate a stacked bar graph 742 reflecting a percentage distribution of the one or more agents and their associated work status time periods.

Referring now to FIG. 7E, a fifth tab 750 is presented that enables the user to generate a report based on a percentage distribution of the work status time periods for one or more agents. In some embodiments, the fifth tab 750 includes the time option enabling the user to select a time period 726, a manager option 732 enabling the user's selection of a manager (e.g., financial institution manager supervising one or more financial institution associates) from a drop-down list of one or more managers associated with the financial institution. In one aspect, the fifth tab 750 initiates the presentation of one or more financial institution associates 734 working under the selected financial institution manager. In some embodiments, the fifth tab 750 also includes one or more work statuses 722 associated with the one or more financial institution associates 734 with corresponding time periods. In some embodiments, the fifth tab 750 may enable a user to generate a stocked bar graph 752 reflecting a percentage distribution of the work status time periods for one or more agents.

Referring now to FIG. 7F, a sixth tab 760 includes a log-in/log-out time of one or more agents. In one aspect, the sixth tab 760 includes a manager option 732 enabling the user's selection of a manager (e.g., financial institution manager supervising one or more financial institution associates) from a drop-down list of one or more managers associated with the financial institution. In another aspect, the sixth tab 760 initiates the presentation of one or more financial institution associates 734 working under the selected financial institution manager. The sixth tab 760 comprises a shift-start time 462 and a shift-stop time 464. In one aspect, the shift-start time 462 includes the time an agent initially logs-in to the system at the beginning of a work day and shift-end time 464 includes the time an agent finally logs-out of the system at the end of the work day.

Referring now to FIG. 7G, a seventh tab 770 includes raw data used to enable the user to generate a report. In one aspect, the sixth tab 770 includes a manager ID 772, a status time 774, a shift end 776, a last status 778, a shift end time 764, a shift start 780, and a shift start time 782. In one aspect, the manager ID 772 may represent an agent, a manager, or any other employee associated with the financial institution. In another aspect, the status time 774 may reflect the time period associated with the last status 778. In yet another aspect, the shift end 776 and shift start 780 may reflect a shift end time 764 and a shift start time 762 respectively.

In some embodiments, the spreadsheet may enable the user to navigate through tabs one through seven at any time.

The present invention leverages the advantages provided by unified communication to assist in the monitoring and reporting process by retrieving a work status indicating the presence information of a financial institution associate. In this way, a user, such as a financial institution manager may monitor the work status associated with the one or more financial institution associates and generate a graphical report for further analysis and measure performance.

While the foregoing disclosure discusses illustrative embodiments, it should be noted that various changes and modifications could be made herein without departing from the scope of the described aspects and/or embodiments as defined by the appended claims. Furthermore, although elements of the described aspects and/or embodiments may be described or claimed in the singular, the plural is contemplated unless limitation to the singular is explicitly stated. Additionally, all or a portion of any embodiment may be utilized with all or a portion of any other embodiment, unless stated otherwise.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An apparatus for monitoring, tracking, and reporting financial institution associate work status, the apparatus comprising:
a computing platform including a memory and a processor in communication with the memory; and
a work status monitoring and reporting module stored in memory, executable by the processor and configured to,
connect to a work status tracking application, at a predetermined time interval to obtain a current work status for a plurality of financial institution associates,
retrieve, from a work status database, a last-in-time work status log entry for each of the one or more financial institution associates,
determine that one or more financial institution associates has a change in work status by comparing the current work status with the last-in-time work status log entry,
create a current work status log entry for the one or more financial institution associates determined to have the change in work status, wherein the current work status log entry indicates (1) a financial institution associate, (2) a work status type and (3) a time associated with the change in work status, and
generate a report that indicates work status of at least one of the financial institution associates over a predetermined time period.

2. The apparatus of claim 1, wherein the work status monitoring and reporting module is further configured to obtain the current work status, wherein the current work status is one of (1) away, (2) busy, (3) online, (4) offline, (5) idle, or (6) be right back.

3. The apparatus of claim 1, wherein the work status monitoring and reporting module is further configured to initiate a presentation of a first user interface, wherein the first user interface enables a user to execute one or more options, wherein the one or more options are (1) timer, (2) report, or (3) administrator, wherein the user's execution of one or more options includes accessing the work status database.

4. The apparatus of claim 3, wherein the work status monitoring and reporting module is further configured to initiate a presentation of a second user interface, wherein the presentation of the second user interface is based on the user's execution of the timer option, wherein the second user interface comprises a start option and a pause option.

5. The apparatus of claim 4, wherein the work status monitoring and reporting module is further configured to enable the user to retrieve from the work status database, the current work status associated with each of the one or more financial institution associates every five seconds based on the user's execution of the start option until the user's execution of the pause option, wherein the user's execution of the pause option enables the work status monitoring and reporting module to temporarily stop retrieving the current work status.

6. The apparatus of claim 3, wherein the work status monitoring a reporting module is further configured to initiate a presentation of a third user interface based on manager user's execution of the report option, wherein the execution of the report option enables the user to generate a report based on the one or more work statuses in the work status database, wherein the report further comprises an aggregated time associated with the one or more work statuses for the one or more financial institution associates over a predetermined time period.

7. The apparatus of claim 6, wherein the work status monitoring and reporting module is further configured to generate the report for each of the one or more financial institution associates based on a percentage of the aggregated time associated with the one or more retrieved work statuses relative to the predetermined time period, wherein the report is a pie chart.

8. The apparatus of claim 6, wherein the work status monitoring and reporting module is further configured to generate the report for each of the one or more financial institution associates working under a financial institution manager based on a percentage of aggregated time associated with the one or more retrieved work statuses relative to the predetermined time period, wherein the report is a comparison of the percentage of aggregated time a work status is associated with a financial institution associate, wherein the report is a stacked bar chart.

9. The apparatus of claim 6, wherein the work status monitoring and reporting module is further configured to generate the report for each of the one or more financial institution associates working under a financial institution manager based on a percentage of aggregated time associated with the one or more retrieved work statuses relative to the predetermined time period, wherein the report is a comparison of the percentage of aggregated time for each of the one or more financial institution associates, wherein the report is a stacked bar chart.

10. The apparatus of claim 6, wherein the work status monitoring and reporting module is further configured to generate the report based on an initial log-in time and a final log-out time.

11. The apparatus of claim 6, wherein the work status monitoring and reporting module is further configured to generate a report based on a user's selection of a time period, wherein selecting a time period further comprises selecting a first time stamp and a second time stamp.

12. The apparatus of claim 6, wherein the work status monitoring and reporting module is further configured to generate a report based on at least a user's selection of one or more financial institution associates working under a financial institution manager, wherein selecting further comprises selecting from a drop-down list of one or more available financial institution managers.

13. The apparatus of claim 3, wherein the work status monitoring and reporting module is further configured to initiate a presentation of a fourth user interface based on a user's execution of the administrator option, wherein the execution of the administrator option is further configured to enable the user manager to clear the work status database.

14. A method for monitoring and reporting real-time user activity, the method comprising:
connecting, using a computing device processor, to a work status tracking application, at a predetermined time interval to obtain a current work status for a plurality of financial institution associates,
retrieving, using a computing device processor, from a work status database, a last-in-time work status log entry for each of the one or more financial institution associates,
determining, using a computing device processor, that one or more financial institution associates has a change in work status by comparing the current work status with the last-in-time work status log entry,
creating, using a computing device processor, a current work status log entry for the one or more financial institution associates determined to have the change in work status, wherein the current work status log entry indicates (1) a financial institution associate, (2) a work status type and (3) a time associated with the change in work status, and
generating, using a computing device processor, a report that indicates work status of at least one of the financial institution associates over a predetermined time period

15. The method of claim 14, wherein retrieving from the work status database further comprises retrieving one or more work statuses associated with one or more financial institution associates, wherein the one or more work statuses is one of (1) away, (2) busy, (3) online, (4) offline, (5) idle, or (6) be right back.

16. The method of claim 14, wherein determining that one or more financial institution associates has the change in work status further comprises retrieving from the work status database, the current work status associated with each of the one or more financial institution associates every five seconds in response to receiving manager user's input.

17. The method of claim 16, wherein connecting to the work status tracking application further comprises authenticating the user based on receipt of one or more authentication credentials.
The method of claim 14, wherein creating further comprises updating the work status database by replacing the last-in time work status with the current work status for the one or more financial institution associates.

19. A computer program product comprising:
a non-transitory computer-readable medium comprising:
a first set of codes for causing a computer to, connect to a work status tracking application, at a predetermined time interval to obtain a current work status for a plurality of financial institution associates,
a second set of codes for causing a computer to, retrieve, from a work status database, a last-in-time work status log entry for each of the one or more financial institution associates,
a third set of codes for causing a computer to, determine that one or more financial institution associates has a change in work status by comparing the current work status with the last-in-time work status log entry,
a fourth set of codes for causing a computer to, create a current work status log entry for the one or more financial institution associates determined to have the change in work status, wherein the current work status log entry indicates (1) a financial institution associate, (2) a work status type and (3) a time associated with the change in work status, and
a fifth set of codes for causing a computer to, generate a report that indicates work status of at least one of the financial institution associates over a predetermined time period.

20. The computer program product of claim 19, wherein the second set of codes is further configured to cause the computer to retrieve one or more work statuses associated with one or more financial institution associates, wherein the one or more work statuses is one of (1) away, (2) busy, (3) online, (4) offline, (5) idle, or (6) be right back.
